(19) United States
(12) Patent Application Publication
(10) Pub. No.: US 2012/0166292 A1
(43) Pub. Date: Jun. 28, 2012

(54) Systems and Methods for Pricing Portfolio Allocations of Ad Deliveries to Online Ads Using a Vickrey-Clarke-Groves Mechanism

(75) Inventors: Eric Bax, Altadena, CA (US); James Li, Monterey Park, CA (US); Nilanjan Roy, Pasedena, CA (US); Joaquin A. Delgado, Santa Clara, CA (US)

(73) Assignee: Yahoo! Inc., Sunnyvale, CA (US)

(21) Appl. No.: 12/979,928

(22) Filed: Dec. 28, 2010

(51) Int. Cl. G06Q 30/00

(52) U.S. Cl. 705/14.71

(57) ABSTRACT

Systems and methods for pricing portfolio allocations of ad deliveries to a plurality of online ads are disclosed. A first set of values is determined, each value of the first set of values representing for an online ad of the plurality of online ads, a bid an advertiser has associated with the online ad. A second set of values is determined, the second set of values representing statistics on variability of payoffs from showing ads. A risk value associated with the publisher is determined. Using a portfolio allocation algorithm, a set of ad delivery allocations associated with the plurality of online ads is determined, and, using a Vickrey-Clarke-Groves mechanism, a set of prices associated with the plurality of online ads is determined, both of which are determined based on the first set of values, the second set of values, and the risk value.

### BACKGROUND

In online advertising marketplaces, advertisers bid to display advertisements on advertising opportunities, sometimes known as ad calls or ad deliveries, provided by content providers known as publishers. Online advertising marketplaces allow advertisers to pay only when their advertisement elicits a response. Accordingly, the expected value of an advertiser's offer may be calculated as a bid associated with an advertisement multiplied by a response rate associated with the advertisement.

Because advertisers may only pay for responses associated with their advertisements, a payoff associated with an advertisement may be random and uncertain. If a publisher is risk-averse, the publisher may choose to award their ad calls over a portfolio of advertising offers from different advertisers. It is desirable to develop improved methods for setting prices associated with the advertisements that are allocated ad deliveries in portfolio allocations.

### BRIEF DESCRIPTION OF THE DRAWINGS

FIG. 1 is a block diagram of an environment in which systems for pricing portfolio allocations of ad deliveries to online ads using a Vickrey-Clarke-Groves mechanism may operate;

FIG. 2 is a block diagram of a system for pricing portfolio allocations of ad deliveries to online ads using a Vickery-Clark-Groves mechanism; and

FIG. 3 is a flow chart of a method for pricing portfolio allocations of ad deliveries to online ads using a Vickery-Clarke-Groves mechanism.

### DETAILED DESCRIPTION OF THE DRAWINGS

The present disclosure is directed to methods and systems for pricing portfolio allocations of ad deliveries to online ads using a Vickrey-Clarke-Groves (VCG) mechanism. Generally, an ad provider and/or ad campaign management system determines for a publisher a set of ad delivery allocations for a plurality of online ads and a set of prices to charge the allocated online ads by using a portfolio allocation technique that both balances revenue to a publisher and risk aversion goals of the publisher, and rewards advertisers who reduce risk.

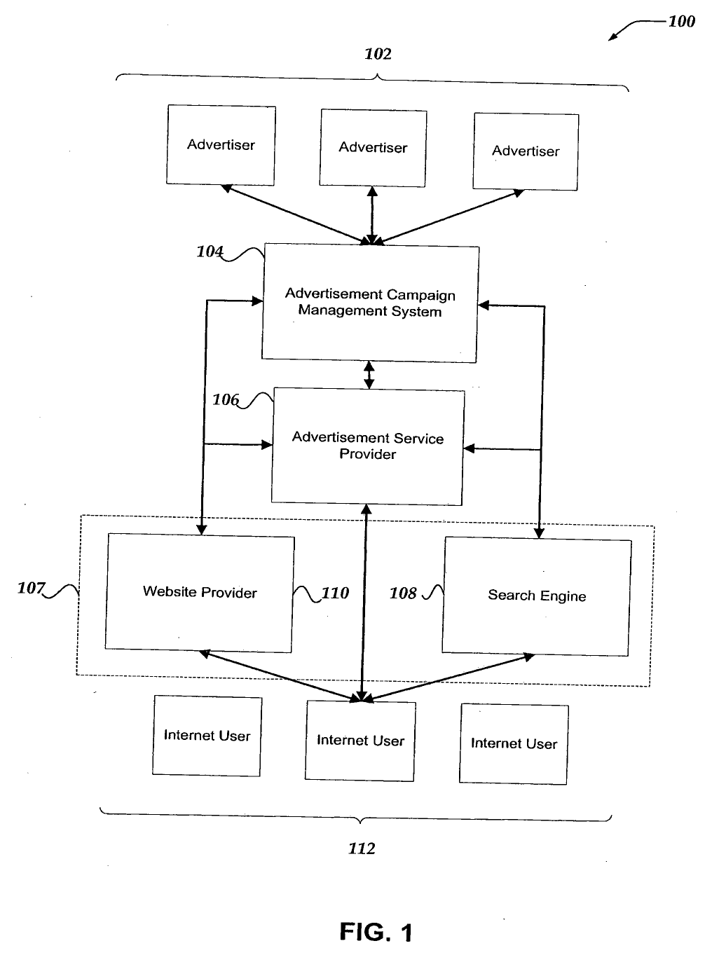

FIG. 1 is a block diagram of an environment in which systems for pricing portfolio allocations of ad deliveries to advertisements using a VCG mechanism may operate. The environment 100 may include a plurality of advertisers 102, an ad campaign management system 104, an ad provider 106, publishers 107 such as a search engine 108 and a content provider 110, and a plurality of users 112.

Generally, an advertiser 102 bids on terms or specified sets of ad calls, and creates one or more online advertisements by interacting with the ad campaign management system 104 in communication with the ad provider 106. Typically, the advertisers 102 may select—and possibly pay additional premiums for—certain targeting options, such as targeting by demographics, geography, behavior (such as past purchase patterns), “social technographics” (degree of participation in an online community) or context (page content, time of day, navigation path, etc.). The advertisement may be a graphical ad such as a banner ad that appears on a website viewed by a user 112, a sponsored search listing that is served to a user 112 in response to a search performed at a search engine, a video ad, a graphical banner ad based on a sponsored search listing, and/or any other type of online marketing media known in the art.

When a user 112 performs a search at a search engine 108, the search engine 108 typically receives a search query comprising one or more keywords. In response to the search query, the search engine 108 returns search results including one or more search listings based on keywords within the search query provided by the user 112. Additionally, the ad provider 106 may receive an ad request based on the received search query. In response to the ad request, the ad provider 106 serves one or more ads created using the ad campaign management system 104 to the search engine 108 and/or the user 112 based on keywords within the search query provided by the user 112.

Similarly, when a user 112 requests content such as a webpage served by the content provider 110, the ad provider 106 may receive an ad request. The ad request may include data such as keywords obtained from the content of the webpage. In response to the ad request, the ad provider 106 serves one or more ads created using the ad campaign management system 104 to the content provider 110 and/or the user 112 based on the keywords within the ad request.

When the advertisements are served, the ad campaign management system 104 and/or the ad provider 106 may record and process information associated with the served ads for purposes such as billing, reporting, or ad campaign optimization. For example, the ad campaign management system 104 and/or the ad provider 106 may record the factors that caused the ad provider 106 to select the served ads; whether the user 112 clicked on a URL or other link associated with one of the served ads; what additional search listings or ads were served with each served ad; a position on a webpage of an advertisement when the user 112 clicked on an ad; and/or whether the user 112 clicked on a different advertisement when an ad was served. One example of an ad campaign management system that may perform these types of actions is disclosed in U.S. patent application Ser. No. 11/413,514, filed Apr. 28, 2006, and assigned to Yahoo! Inc.

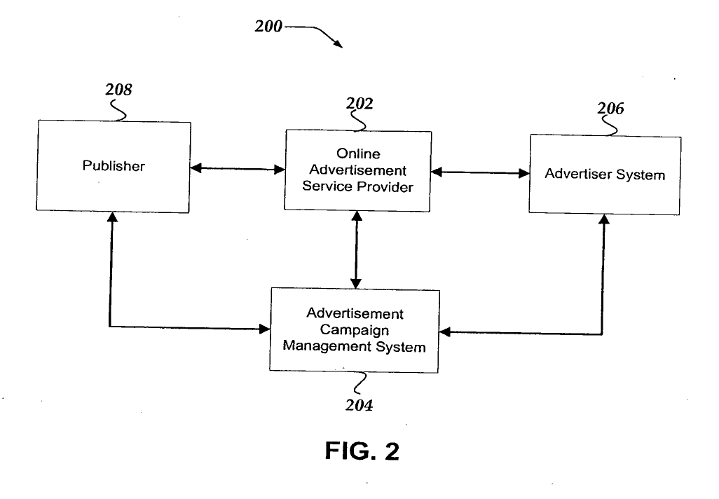

FIG. 2 is a block diagram of a system for pricing portfolio allocations of ad deliveries to online ads using a VCG mechanism. Generally, the system 200 may include an ad provider 202, an ad campaign management system 204, an advertiser system 206 (also referred to below as an advertiser), and a publisher 208. In some implementations the ad campaign management system 204 may be part of the ad provider 202, where in other implementations, the ad campaign management system 204 is distinct from the ad provider 202.

The ad provider 202, ad campaign management system 204, advertiser system 206, and publisher 208 may communicate with each other over one or more external or internal networks. The networks may include local area networks (LAN), wide area networks (WAN), and/or the Internet, and may be implemented with wireless or wired communication mediums such as wireless fidelity (WiFi), Bluetooth, landlines, satellites, and/or cellular communications. Further, the ad provider 202, ad campaign management system 204, advertiser system 206, and publisher 208 may be implemented as software code or instructions that may be stored in a tangible computer-readable storage medium, and be executed by one or more hardware processors of a single server, plurality of servers, or any other type of computing device known in the art.

The ad provider 202 and/or ad campaign management system 204 receive bids from the advertisers 206 representing for each online ad of the advertiser 206, a price the advertiser 206 is willing to pay for an action associated with the online ad. It will be appreciated that the advertiser 206 may be willing to pay for actions associated with an advertisement such as an impression, click, lead, or acquisition. The ad provider 202 and/or ad campaign management system 204 determines a set of values based on the received bids, where each value of the second set of values represents for an online ad of the plurality of online ads, a bid an advertiser 206 has associated with the online ad.

The ad provider 202 and/or campaign management system 204 receives data on variations in payouts for different ads and data on correlations between payouts among sets of ads. The ad provider 202 and/or ad campaign management system 204 determines a second set of values based on the received data.

The ad provider 202 and/or ad campaign management system 204 receives an indication from the publisher 208 representing a risk level of the publisher 208. For example, the publisher 208 may indicate that they are not willing to accept risk and prefer to be compensated based only on an impression basis for online ads that the publisher 208 displays, or the publisher 208 may indicate that they are willing to accept risk and be compensated based on a click, a lead or an acquisition associated with online ads that the publisher 208 displays. The ad provider 202 and/or ad campaign management system 204 determines a risk value for the publisher 208 based on the received risk indication.

The ad provider 202 and/or ad campaign management system 204 may then, using a portfolio allocation algorithm, determine for the publisher 208 a portfolio allocation based on the bids of the first set of values, the payoff variation statistics of the second set of values, and the risk value. The ad provider 202 and/or ad campaign management system 204 may then, using a VCG algorithm, determine prices for showing the ads in the portfolio allocation. When the ad provider 202 receives a request for an online ad from the publisher 208, the ad provider 202 may then identify and serve an online ad to the publisher 208 based on the determined set of ad delivery allocations and the set of prices.

The use of a VCG algorithm to determine prices for a portfolio allocation is described in more detail below. A VGC mechanism may determine ad delivery prices for online ads allocated by using a portfolio allocation technique that both balances revenue to a publisher and risk aversion goals of the publisher, and rewards advertisers who reduce risk. Generally, the VCG method described below introduces an extra participant that represents the risk aversion of a publisher.

In classical portfolio methods, an investor has a set amount of funds to allocate among a number of investment opportunities (n). In the following equations, X₁, X₂, . . . , Xₙ represent returns for investment opportunities and μ=(μ₁, μ₂, . . . , μₙ) represents the expected returns, such that:

∀i:μᵢ=EXᵢ.

Further, Σ is a matrix of covariances of returns:

∀i≠j:Σᵢⱼ=Cov(Xᵢ,Xⱼ),

and

∀I:Σᵢᵢ=Var(Xᵢ).

Weights in a portfolio allocation are represented as w=(w₁, w₂, . . . , wₙ), with wᵢ being a fraction of funds allocated to investment opportunity i. The expected return for the portfolio may then be expressed as:

$${w}^{T} μ = {\sum }_{i = 1}^{n} {w}_{i} {μ}_{i} ,$$

and the variance of returns may be expressed as:

w^{T}Σw.

A profit-seeking but risk-averse investor may solve the equation:

$${w}^{*} = arg {max}_{w} ( {w}^{T} μ - q {w}^{T} \sum w ) ,$$

subject to w≧0 and 1^{T}w=1 to compute a portfolio allocation. The investor selects a value of q to mediate a tradeoff between profit-seeking and risk-aversion. For example, q=0 may express pure profit-seeking and no risk aversion.

The VCG auction mechanism charges bidders based on the harm their participation causes other bidders. As a result, the VCG auction mechanism may be considered a truthful mechanism, meaning that for each bidder, bidding their true value is a dominant strategy. In the following equations, there are a set of outcomes (A) and a set of participants. Each participant (i) submits valuations vᵢ(a) for all outcomes aεA. The VCG mechanism selects an outcome a* that maximizes the sum of valuations:

$${a}^{*} = arg {max}_{a ∈ A} {\sum }_{i} {v}_{i} ( a ) .$$

Further, the VCG mechanism charges each participant i:

$${p}_{i} = [ {max}_{a ∈ A} {\sum }_{j \neq i} {v}_{j} ( a ) ] - {\sum }_{j \neq i} {v}_{j} ( {a}^{*} ) .$$

In applying the VGC mechanism to portfolio allocations, the set of outcomes may be defined as:

A={w:w^{T}1=1, w≧0}.

Assuming there are n advertising offers, each offer is a participant submitting a valuation function:

∀iε1, . . . ,n:vᵢ(w)=wᵢμᵢ.

In other words, an advertiser issuing offer i values their allocation linearly in a fraction of the ad delivery allocations (ad calls) that they receive. A risk-aversion of a publisher is represented as an (n+1)^{st} participant. This participant submits a valuation function:

vₙ₊₁(w)=−qw^{T}Σw.

When the VCG mechanism selects an outcome to maximize the sum of the valuations:

$${a}^{*} = arg {max}_{a ∈ A} {\sum }_{i} {v}_{i} ( a ) ,$$

the VCG mechanism performs portfolio optimization:

$${w}^{*} = {arg max}_{\{ w : {w}^{T} 1 - 1 , w \geq 0 \}} {w}^{T} μ - q {w}^{T} \sum w ,$$

where w* is a* for the portfolio setting. The VCG mechanism charges each participant (i):

$${p}_{i} = [ {max}_{a ∈ A} {\sum }_{j \neq i} {v}_{j} ( a ) ] - {\sum }_{j \neq i} {v}_{j} ( {a}^{*} ) .$$

Accordingly, the VCG mechanism charges each of the first n participants:

$$∀ i ∈ 1 , … , n : {p}_{i} = [ { max}_{\{ w : {w}^{T} 1 - 1 , w \geq 0 \}} {w}^{T} μ - {w}_{i} {μ}_{i} - q {w}^{T} \sum w ] - [ {w}^{* T} μ - q {w}^{* T} \sum {w}^{*} - {w}_{i}^{*} {μ}_{i} ] ,$$

which is a difference between the maximum sum of valuations when offer i submits a valuation of zero for all fractions of ad calls and the maximum sum of valuations over other participants when offer i submits a valuation of wᵢμᵢ.

The VCG mechanism charges the (n+1)^{st} participant:

$${p}_{n + 1} = { max}_{\{ w : {w}^{T} 1 - 1 , w \geq 0 \}} {w}^{T} μ - {w}^{* T} μ ,$$

where w^{T}μ represents the expected revenue for a risk-neutral publisher. In this case, the allocation is to the advertiser with the highest offer (or advertisers with the highest offer). Accordingly, the expected revenue foregone by a publisher due to risk aversion may be expressed as:

$${p}_{n + 1} = { max}_{i ∈ \{ 1 , … , n \}} {μ}_{i} - {w}^{* T} μ .$$

In the equations above, p₁, . . . , pₙ are per-allocation prices. Accordingly, to convert the price per ad delivery, each bid price is divided by a number of ad deliveries allocated to an online ad. The per-ad delivery price applies directly to offers based on a number of impressions of an online ad. However, to calculate prices for an online ad based on a number of clicks, a number of leads, or a number of acquisitions associated with the online ad, the per-ad delivery price should be divided by the estimated rate of clicks, leads, or acquisitions for the online ad.

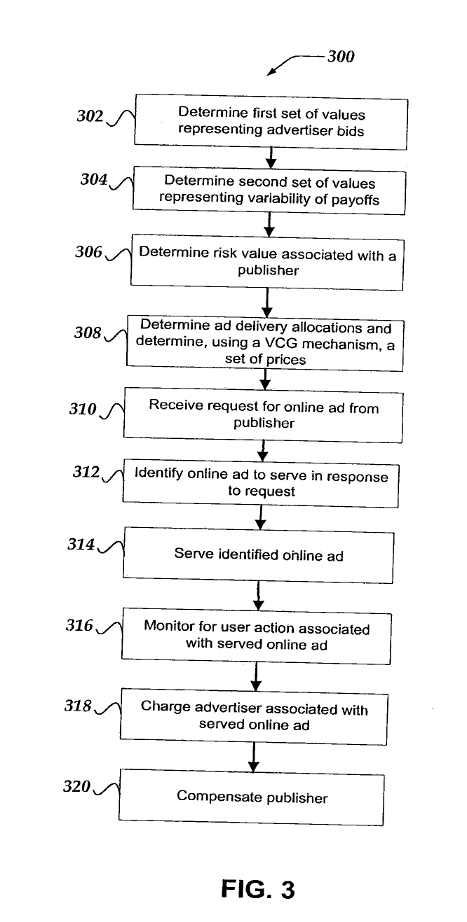

FIG. 3 is a flow chart of a method for pricing portfolio allocations of ad deliveries to online ads using a Vickery-Clarke-Groves mechanism. It will be appreciated that systems such as the ad provider and/or ad campaign management system described above comprising a memory and a processor configured to execute instructions stored in the memory may perform acts of the method described below.

The method 300 begins at step 302 with the ad provider and/or ad campaign management system determining a first set of values, each value of the first set of values representing for an online ad of the plurality of online ads, a bid an advertiser has associated with the online ads. In some implementations, the advertiser associates a bid with an online ad by interacting with the ad campaign management system.

At step 304, the ad provider and/or ad campaign management system determines a second set of values, statistics on variability of payoffs from advertisers for showing ads. The statistics may include variances of payoffs for individual ads and correlations of payoffs between pairs of ads. The statistics may be based on the history of payoffs for individual ads or pairs of ads, on histories of payoffs for similar ads or ad pairs. The statistics may combine these sources, for example, a Bayesian approach that uses histories for similar cases to form priors and uses histories for individual ads or pairs to adjust the priors to form posteriors.

At step 306, the ad provider and/or ad campaign management system determines a risk value associated with the publisher. In some implementations, the publisher indicates a risk level of the publisher by interacting with the ad campaign management system.

At step 308, the ad provider and/or ad campaign management system determines for the publisher, using a portfolio allocation algorithm such as the algorithm described above, a set of ad delivery allocations associated with the plurality of online ads, and determines, using a Vickrey-Clarke-Groves mechanism such as the mechanism described above, a set of prices associated with the plurality of online ads based on the first set of values, the second set of values, and the risk value.

At step 310, the ad provider receives a request for an online advertisement from the publisher. At step 312, the ad provider identifies an online ad to serve in response to the request based on keywords included in the request, and the set of allocations and the set of prices associated with the plurality of online ads determined at step 308. At step 314, the ad provider serves the identified online ad to the publisher for display to an Internet user.

At step 316, the ad provider and/or ad campaign management system may monitor for user actions associated with the served online ad displayed to the Internet user, such as a click-through, lead or acquisition. At step 318, the ad provider and/or ad campaign management system may charge the advertiser associated with the served online ad based on the set of prices determined at step 308 and one or more monitored user actions associated with the Internet user. Similarly, at step 320, the ad provider and/or ad campaign management system may compensate the publisher based on the set of prices determined at step 308 and one or more monitored user actions associated with the Internet user.

FIGS. 1-3 disclose systems and methods for pricing portfolio allocations of ad deliveries to online ads using a Vickrey-Clarke-Groves (VCG) mechanism. As discussed above an ad provider and/or ad campaign management system, for example, may determine for a publisher a set of ad delivery allocations for a plurality of online ads by using a portfolio allocation technique that balances revenue to a publisher and risk aversion goals of a publisher, and rewards advertisers who reduce risk. The ad provider and/or ad campaign management system may determine a set of prices to charge the allocated online ads using a VCG mechanism by introducing a participant associated with risk.

The allocation may be over sets of online ads rather than single ads. For example, the sets may comprise a set of ads that pay per impression, a set of ads that pay per click, and a set of ads that pay per lead or acquisition. Bids can be averaged over ads in sets to produce set-level bids, and statistics on payoffs can be aggregated at the level of sets. Then the ad calls are allocated across sets rather than single ads. When an ad call is allocated to a set, another mechanism may be used to select an ad from within the set. The VCG prices for sets can be used to compute price adjustments for ads at the set level.

The portfolio allocation algorithm may operate on uncertainty about statistics on variability of payoffs in addition to the statistics as well. Example allocation methods include robust optimization algorithms.

It is intended that the foregoing detailed description be regarded as illustrative rather than limiting, and that it be understood that it is the following claims, including all equivalents, that are intended to define the spirit and scope of this invention.

1. A method for pricing portfolio allocations of ad deliveries to a plurality of online ads, the method comprising:
determining a first set of values, each value of the first set of values representing for an online ad of the plurality of online ads, a bid an advertiser has associated with the online ad;
determining a second set of values, the second set of values representing statistics on payoffs for the plurality of online ads;
determining a risk value associated with the publisher;
determining for the publisher, using a portfolio allocation algorithm, a set of ad delivery allocations associated with the plurality of online ads based on the first set of values, the second set of values, and the risk value; and
determining, using a Vickrey-Clarke-Groves mechanism, a set of prices associated with the plurality of online ads based on the first set of values, the second set of values, and the risk value.

2. The method of claim 1, further comprising:
receiving a request for an online ad from the publisher;
identifying an online ad to serve in response to the request based on the determined set of delivery allocations; and
serving the identified online ad.

3. The method of claim 2, further comprising:
charging an advertiser associated with the online ad served in response to the request based on the determined set of prices.

4. The method of claim 2, further comprising:
monitoring for a user action associated with the online ad served in response to the request;
detecting a user action associated with the online ad served in response to the request; and
charging an advertiser associated with the online ad served in response to the request based on the determined set of prices and the detected user action.

5. The method of claim 4, wherein the user action is a click-through associated with the online ad served in response to the request.

6. The method of claim 4, wherein the user action is a lead associated with the online ad served in response to the request.

7. The method of claim 4, wherein the user action is an acquisition associated with the online ad served in response to the request.

8. The method of claim 4, further comprising:
compensating the publisher based on the determined set of prices and the detected user action.

9. A computer-readable storage medium comprising a set of instructions for pricing portfolio allocations of ad deliveries to a plurality of online ads, the set of instructions to direct a processor to perform acts of:
determining a first set of values, each value of the first set of values representing for an online ad of the plurality of online ads, a bid an advertiser has associated with the online ad;
determining a second set of values, the second set of values representing statistics on payoffs for the plurality of online ads;
determining a risk value associated with the publisher;
determining for the publisher, using a portfolio allocation algorithm, a set of ad delivery allocations associated with the plurality of online ads based on the first set of values, the second set of values, and the risk value; and
determining, using a Vickrey-Clarke-Groves mechanism, a set of prices associated with the plurality of online ads based on the first set of values, the second set of values, and the risk value.

10. The computer-readable storage medium of claim 9, further comprising a set of instructions to direct the processor to perform acts of:
receiving a request for an online ad from the publisher;
identifying an online ad to serve in response to the request based on the determined set of delivery allocations; and
serving the identified online ad to the publisher.

11. The computer-readable storage medium of claim 10, further comprising a set of instructions to direct the processor to perform acts of:
charging an advertiser associated with the online ad served in response to the request based on the determined set of prices.

12. The computer-readable storage medium of claim 10, further comprising a set of instructions to direct the processor to perform acts of:
monitoring for a user action associated with the online ad served in response to the request;
detecting a user action associated with the online ad served in response to the request;
charging an advertiser associated with the online ad served in response to the request based on the determined set of prices and the detected user action; and.
compensating the publisher based on the determined set of prices and the detected user action.

13. The computer-readable storage medium of claim 12, wherein the user action is a click-through associated with the online ad served in response to the request.

14. The computer-readable storage medium of claim 12, wherein the user action is a lead associated with the online ad served in response to the request.

15. The computer-readable storage medium of claim 12, wherein the user action is an acquisition associated with the online ad served in response to the request.

16. A system for pricing portfolio allocations of ad deliveries to a plurality of online ads, the system comprising:
an ad provider comprising a memory and a processor configured to execute instructions stored in the memory, the ad provider configured to:
determine a first set of values, each value of the first set of values representing for an online ad of the plurality of online ads, a bid an advertiser has associated with the online ad;
determine a second set of values, the second set of values representing statistics on payoffs for the plurality of online ads;
determine a risk value associated with the publisher;
determine for the publisher, using a portfolio allocation algorithm, a set of ad delivery allocations associated with the plurality of online ads based on the first set of values, the second set of values, and the risk value; and
determine, using a Vickrey-Clarke-Groves mechanism, a set of prices associated with the plurality of online ads based on the first set of values, the second set of values, and the risk value.

17. The system of claim 16, wherein the ad provider is further configured to:
receive a request for an online ad from the publisher;
identify an online ad to serve in response to the request based on the determined set of delivery allocations; and
serve the identified online ad to the publisher.

18. The system of claim 17, wherein the ad provider is further configured to:
monitor for a user action associated with the online ad served in response to the request;
detect a user action associated with the online ad served in response to the request; and
charge an advertiser associated with the online ad served in response to the request based on the determined set of prices and the detected user action.

19. The system of claim 18, wherein the ad provider is further configured to:
compensate the publisher based on the determined set of prices and the detected user action.

20. A method for pricing portfolio allocations of ad deliveries to a plurality of sets of online ads, the method comprising:
determining a first set of values, each value of the first set of values representing for a set of online ads of the plurality of sets of online ads, a bid an advertiser has associated with the set of online ads;
determining a second set of values, the second set of values representing statistics on payoffs for the plurality of sets of online ads;
determining a risk value associated with the publisher;
determining for the publisher, using a portfolio allocation algorithm, a set of ad delivery allocations associated with the plurality of sets of online ads based on the first set of values, the second set of values, and the risk value; and
determining, using a Vickrey-Clarke-Groves mechanism, a set of prices associated with the plurality of sets of online ads based on the first set of values, the second set of values, and the risk value.
